(19) United States
(12) Patent Application Publication
(10) Pub. No.: US 2021/0166178 A1
(43) Pub. Date: Jun. 3, 2021

(54) SYSTEM FOR IMPLEMENTING PREDICTIVE RESOURCE TRANSFERS

(71) Applicant: BANK OF AMERICA CORPORATION, Charlotte, NC (US)

(72) Inventors: Brian J. Kehner, Wilmington, DE (US); John E. Scully, Chicago, IL (US); Jill Marie Moser, Louisville, KY (US); Robert A. Pascal, Marblehead, MA (US); Joshua Dean, Naperville, IL (US)

(73) Assignee: BANK OF AMERICA CORPORATION, Charlotte, NC (US)

(21) Appl. No.: 17/109,319

(22) Filed: Dec. 2, 2020

Related U.S. Application Data
(60) Provisional application No. 62/942,275, filed on Dec. 2, 2019.

(51) Int. Cl. G06Q 10/06; G06N 5/04; G06N 20/00; G06F 16/23; G06F 16/29; G06Q 30/02; G06Q 10/10; G06Q 40/02; G06Q 20/40; H04L 29/08; G08C 19/00

(52) U.S. Cl. CPC G06Q 10/06315; G06N 5/04; G06N 20/00; G06F 16/2379; G06F 16/29; H04L 67/141; G06Q 10/103; G06Q 40/02; G06Q 20/40; H04L 67/18; G08C 19/00; G06Q 30/0205

(57) ABSTRACT

Systems, computer program products, and methods are described herein for implementing predictive resource transfers. The present invention is configured to initiate a remote access to a computing device associated with a merchant; request, via the remote access, information associated with one or more resources associated with the merchant; electronically receive information associated with one or more historical resource transfers executed by one or more users within a predetermined distance from a location of the merchant; predict the market need for the one or more resources associated with the merchant based on at least initiating the machine learning engine on the one or more historical resource transfers; and generate one or more resource transfer requests associated with at least a subset of the one or more resources associated with the merchant based on at least the market need.

### PRIORITY CLAIM

This application claims priority to U.S. Provisional Application Ser. No. 62/942,275, entitled “SYSTEM FOR RESOURCE TRANSFER REQUESTS”, filed Dec. 2, 2019, which is incorporated herein by reference in its entirety.

### FIELD OF THE INVENTION

The present invention embraces a system for implementing predictive resource transfers.

### BACKGROUND

There is a need for a system for implementing predictive resource transfers to establish a communication link between computing devices of the user and computing devices of resource entity.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for resource transfer requests is presented. The system comprising: at least one non-transitory storage device; and at least one processing device coupled to the at least one non-transitory storage device, wherein the at least one processing device is configured to: initiate a remote access to a computing device associated with a merchant; request, via the remote access, information associated with one or more resources associated with the merchant; electronically receive information associated with one or more historical resource transfers executed by one or more users within a predetermined distance from a location of the merchant, wherein the one or more historical resource transfers comprises at least one or more same or similar resources as that of the one or more resources associated with the merchant, and a time of year that the historical resource transfers were executed by the one or more users; initiate a machine learning engine on the one or more historical resource transfers to predict a market need for the one or more resources associated with the merchant; predict the market need for the one or more resources associated with the merchant based on at least initiating the machine learning engine on the one or more historical resource transfers; and initiate an analytical recommendation engine configured to generate one or more resource transfer requests associated with at least a subset of the one or more resources associated with the merchant based on at least the market need.

In some embodiments, the at least one processing device is further configured to: transmit control signals configured to cause the computing device associated with the merchant to display, via an authorization interface, the one or more resource transfer requests associated with at least a subset of the one or more resources associated with the merchant; receive, via the authorization interface, a merchant input authorizing a distribution of the one or more resource transfer requests associated with at least a subset of the one or more resources associated with the merchant; and store the one or more resource transfer requests associated with at least a subset of the one or more resources associated with the merchant in a merchant database.

In some embodiments, the at least one processing device is further configured to define one or more virtual geographical boundaries around a location of the merchant, wherein defining further comprises: receiving from the computing device, the location of the merchant and one or more radial distance inputs; and defining the one or more virtual geographic boundaries around the location of the merchant based on at least each of the one or more radial distance inputs.

In some embodiments, the at least one processing device is further configured to: electronically receive, from the computing device associated with the merchant, one or more conditions associated with generating the one or more resource transfer requests for the one or more virtual geographic boundaries; and generate the one or more resource transfer requests associated with at least the subset of the one or more resources associated with the merchant based on at least the one or more conditions.

In some embodiments, the at least one processing device is further configured to: continuously scan the one or more virtual geographic boundaries for an indication that the one or more computing devices of the one or more users has entered the at least one of the one or more virtual geographic boundaries; and electronically receive the indication that the one or more computing devices of the one or more users has entered the at least one of the one or more virtual geographic boundaries.

In some embodiments, the at least one processing device is further configured to: establish a communication link with the one or more computing devices of the one or more users determined to have entered the at least one of the one or more virtual geographic boundaries; generate the one or more resource transfer requests based on at least one of the one or more virtual geographic boundaries that the one or more computing devices of the one or more users has entered, wherein generating further comprises generating the one or more resource transfer requests based on at least the one or more conditions; and transmit, via the established communication link, control signals configured to cause the one or more computing devices of the one or more users to display the one or more resource transfer requests.

In some embodiments, the at least one processing device is further configured to: apply the one or more conditions to the one or more resource transfer requests stored in the merchant database; retrieve, from the merchant database, the one or more resource transfer requests that satisfy the one or more conditions associated with the one or more virtual geographic boundaries; and transmit, via the established communication link, control signals configured to cause the one or more computing devices of the one or more users to display the one or more resource transfer requests that have satisfied the one or more conditions.

In some embodiments, the at least one processing device is further configured to: determine one or more proximate merchants that are located within the one or more virtual geographic boundaries; and generate the one or more resource transfer requests, wherein the one or more resource transfer requests are associated with at least the subset of the one or more resources associated with the merchant and a subset of the one or more resources associated with the one or more proximate merchants that are located within the one or more virtual geographic boundaries.

In some embodiments, the at least one processing device is further configured to: determine one or more peer resource transfers executed by one or more peer merchants, wherein the one or more peer resource transfers are associated with one or more same or similar resources as that of the one or more resources associated with the merchant; and initiate the analytical recommendation engine configured to generate the one or more resource transfer requests associated with at least a subset of the one or more resources associated with the merchant based on at least the one or more peer resource transfers executed by the one or more peer merchants.

In another aspect, a computer implemented method for implementing predictive resource transfers is presented. The method comprising: initiating a remote access to a computing device associated with a merchant; requesting, via the remote access, information associated with one or more resources associated with the merchant; electronically receiving information associated with one or more historical resource transfers executed by one or more users within a predetermined distance from a location of the merchant, wherein the one or more historical resource transfers comprises at least one or more same or similar resources as that of the one or more resources associated with the merchant, and a time of year that the historical resource transfers were executed by the one or more users; initiating a machine learning engine on the one or more historical resource transfers to predict a market need for the one or more resources associated with the merchant; predicting the market need for the one or more resources associated with the merchant based on at least initiating the machine learning engine on the one or more historical resource transfers; and initiating an analytical recommendation engine configured to generate one or more resource transfer requests associated with at least a subset of the one or more resources associated with the merchant based on at least the market need.

In yet another aspect, a computer program product for implementing predictive resource transfers is presented. The computer program product comprising a non-transitory computer-readable medium comprising code causing a first apparatus to: initiate a remote access to a computing device associated with a merchant; request, via the remote access, information associated with one or more resources associated with the merchant; electronically receive information associated with one or more historical resource transfers executed by one or more users within a predetermined distance from a location of the merchant, wherein the one or more historical resource transfers comprises at least one or more same or similar resources as that of the one or more resources associated with the merchant, and a time of year that the historical resource transfers were executed by the one or more users; initiate a machine learning engine on the one or more historical resource transfers to predict a market need for the one or more resources associated with the merchant; predict the market need for the one or more resources associated with the merchant based on at least initiating the machine learning engine on the one or more historical resource transfers; and initiate an analytical recommendation engine configured to generate one or more resource transfer requests associated with at least a subset of the one or more resources associated with the merchant based on at least the market need.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for implementing predictive resource transfers, in accordance with an embodiment of the invention; and

FIG. 2 illustrates a high level process flow for implementing predictive resource transfers, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” is an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, a “resource transfer” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. In the context of an entity such as a financial institution, a resource transfer may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that invokes or is detectable by the financial institution. In some embodiments, the user may authorize a resource transfer using at least a payment instrument (credit cards, debit cards, checks, digital wallets, currency, loyalty points), and/or payment credentials (account numbers, payment instrument identifiers). A resource transfer may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. In this regard, resource transfers or transactions may refer to the user initiating a purchase for a product, service, or the like from a merchant. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” refers to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application. In accordance with embodiments of the invention, the term “module” with respect to an apparatus may refer to a hardware component of the apparatus, a software component of the apparatus, or a component of the apparatus that comprises both hardware and software. In accordance with embodiments of the invention, the term “chip” may refer to an integrated circuit, a microprocessor, a system-on-a-chip, a microcontroller, or the like that may either be integrated into the external apparatus or may be inserted and removed from the external apparatus by a user.

As used herein, “authentication credentials” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

Small business owners (merchants) face a number of challenges, whether they offer goods or services to their customers. One such challenge is inventory management. Inventory management is the part of supply chain management that aims to always have the right products in the right quantity for sale, at the right time. When done effectively, businesses reduce the costs of carrying excess inventory while maximizing sales. Modern technology has enabled financial institutions to be uniquely positioned to not only help their merchant customers to conduct everyday business activities, but also have the capability to provide valuable input to optimize their business process while maximizing sales. For example, financial institutions have widely adopted big data analytics—a complex process of examining large and varied data sets—to generate information such as hidden patterns, unknown correlations, market trends, customer preferences, or the like, that can help their merchant customers to make informed business decisions. The present invention contemplates a system, method, and computer program product to develop a framework that is capable of ingesting various types of data related to a merchant's business operations, implement sophisticated data analysis on the various types of data, and generate suggestions based on queries and activities to facilitate profitable interactions with their customers.

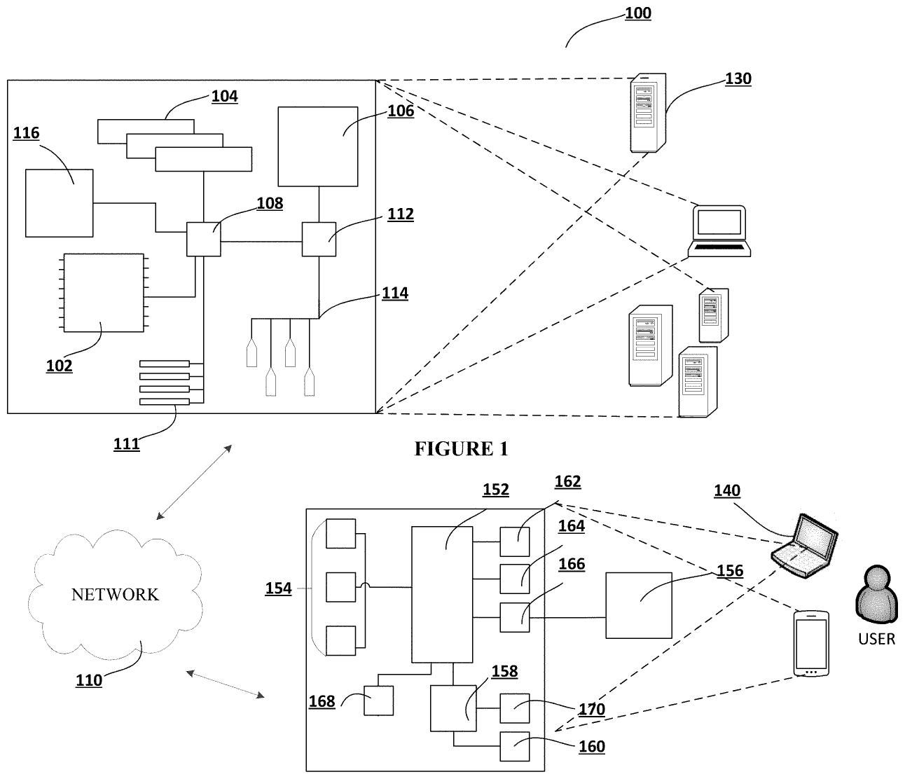

FIG. 1 presents an exemplary block diagram of the system environment for implementing predictive resource transfers 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute resource transfers using one or more applications stored thereon. The one or more applications may be configured to communicate with the system 130, execute a transaction, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, personal digital assistants, servers, blade servers, mainframes, and other appropriate computers. The user input system 140 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application and allows memory reuse for better utilization of the memory resources when the data sizes are large.

The high-speed interface 1408 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140 or may also store applications or other information therein. In some embodiments, expansion memory may include instructions to carry out or supplement the processes described above and may include secure information also. For example, expansion memory may be provided as a security module for user input system 140 and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation—and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

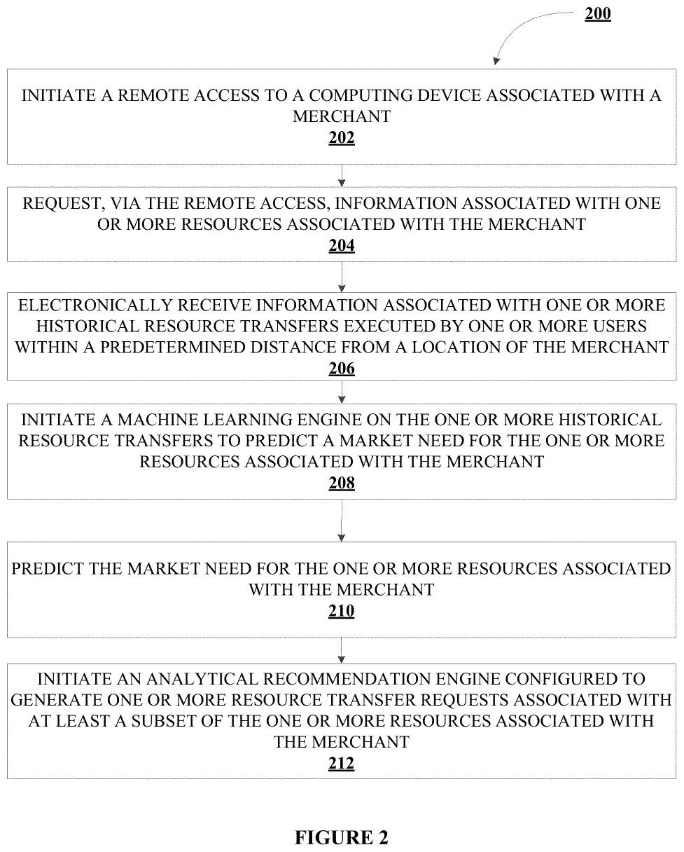

FIG. 2 illustrates a process flow for implementing predictive resource transfers 200, in accordance with an embodiment of the invention. As shown in block 202, the process flow includes initiating a remote access to a computing device associated with a merchant. Typically, remote access is the ability to connect and gain access to internal network resources associated with the merchant that are physically disbursed. In some embodiments, internal network resources may refer to one or more resources, information, and/or hardware devices that can be accessed by a group of computing devices through the use of a shared connection. In one aspect, the one or more resources may include an inventory of the merchant, including but not limited to, the one or more goods and/or services that are in various stages of being made ready for sale.

Next, as shown in block 204, the process flow includes requesting, via the remote access, information associated with one or more resources associated with the merchant. In this regard, the system may be configured to initiate, via an application stored on the computing device of the merchant, the request to access information associated with the one or more resources. In one aspect, the information associated with the one or more resources may include location information, requisitions, back orders, required level of resources on hand, reorder points, lead times, resource error tracking, and/or the like.

Next, as shown in block 206, the process flow includes electronically receiving information associated with one or more historical resource transfers executed by one or more users within a predetermined distance from a location of the merchant. In some embodiments, in response to receiving the information associated with the one or more resources, the system may be configured to determine one or more factors that affect the one or more resources. In one aspect, the one or more factors may include, but is not limited to, financial factors, supplier information, financial market information, extent of the effect of weather on each resource, extent of local competition, and/or the like.

Next, as shown in block 208, the process flow includes initiating a machine learning engine on the one or more historical resource transfers to predict a market need for the one or more resources associated with the merchant. In some embodiments, the technology platform of the present invention may be configured to employ a robust ensemble of machine learning algorithms/models and related systems to predict a market need for the one or more resources. Using these finely tuned and perpetually evolving and tunable machine learning algorithms/models, the system may be capable of predicting the market trend with high accuracy and, in some embodiments, in real-time (e.g., as the exceptions occur or shortly thereafter)

Accordingly, the machine learning algorithms/models may be implemented by a plurality of computing servers (e.g., a combination of web servers and private servers) that implement one or more ensembles of machine learning algorithms/models. The ensemble of machine learning models may include hundreds and/or thousands of machine learning models that work together to not only determine a market need for the resources, but also identify a subset of the one or more resources for the merchant to prioritize when considering the transfer of the resources as part of the merchant's business model. The machine learning algorithms/models may additionally utilize the information associated with the resources and the factors affecting the resources to continuously improve or accurately tune weightings associated with features of the one or more of the machine learning algorithms/models defining the ensembles. Accordingly, as shown in block 210, the process flow includes predicting the market need for the one or more resources associated with the merchant.

The ensembles of machine learning models may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) can be used in generating data relevant to the system 130.

Next, as shown in block 212, the process flow includes initiating an analytical recommendation engine configured to generate one or more resource transfer requests associated with at least a subset of the one or more resources associated with the merchant. In some embodiments, the resource transfer requests may be an offering for the transfer of resources to one or more users. In one aspect, the offering may represent additional value to the users in addition to the resources themselves, such as availability, convenient delivery, technical support or quality of service, a reduction in price of the resources, and/or the like, or any combination thereof. Examples of offers may include, but is not limited to, buy one get one free, contractual discount, early payment discount, free shipping, order specific discounts, price-break discount, seasonal discount, trade discount, trade-in credit, volume discount, and/or the like, or any combination thereof. In some embodiments, the resource transfer request may be provided in the form of a machine readable optical label containing information about the associated resources. In one example, the machine readable optical label may include a quick response (QR) code containing data for a locator, identifier, or tracker that points to a website or application for the resource transfer request.

In some embodiments, the system may be configured to transmit control signals configured to cause the computing device associated with the merchant to display, via an authorization interface, the one or more resource transfer requests associated with at least a subset of the one or more resources associated with the merchant. In response, the system may be configured to receive, via the authorization interface, a merchant input authorizing a distribution of the one or more resource transfer requests associated with at least a subset of the one or more resources associated with the merchant. In response, the system may be configured to store the one or more resource transfer requests associated with at least a subset of the one or more resources associated with the merchant in a merchant database.

In some embodiments, the system may be configured to define one or more virtual geographical boundaries around a location of the merchant. In this regard, the system may be configured to receive from the computing device, the location of the merchant and one or more radial distance inputs. In response, the system may be configured to define the one or more virtual geographic boundaries around the location of the merchant based on at least each of the one or more radial distance inputs. In some embodiments, the virtual geographic boundaries may include a geo-fencing parameter, dynamically generating a radius around a point of location, such as a shopping center, a strip mall, and/or an area with multiple merchants. In one aspect, the geo-fence may be a circular boundary surrounding the location of the merchant. In another aspect, the geo-fence may be a polygon.

In some embodiments, the system may be configured to electronically receive, from the computing device associated with the merchant, one or more conditions associated with generating the one or more resource transfer requests for the one or more virtual geographic boundaries. In some embodiments, the one or more conditions may include a predetermined number of users. For example, the merchant may honor the resource transfer request from the first 10 users who approach the location of the merchant with the resource transfer request. In some other embodiments, the one or more conditions may include associating a resource transfer request with a virtual geographic boundary. In one example, the merchant may provide a resource transfer request with a reduction in price of one or more resources for any user who is within a specific virtual geographic boundary. In some embodiments, the virtual geographic boundary may be overlapping, i.e., virtual geographic boundaries with smaller radial distance inputs being at least partially encapsulated within the virtual geographic boundaries with larger radial distance inputs. In some other embodiments, each virtual geographic boundary may abut an adjacent virtual boundary without any overlap. In one aspect, the merchant may associate a resource transfer request with two or more virtual geographic boundaries that may not be adjacent to each other and provide the resource transfer request to any user who is within those two or more virtual geographic boundaries. In this regard, the merchant may provide a resource transfer request to users within a first virtual geographic boundary and a third geographic boundary but not a second virtual geographic boundary, with the second geographic boundary being sandwiched between the first virtual geographic boundary and the third virtual geographic boundary.

In response, the system may be configured to electronically receive the indication that the one or more computing devices of the one or more users has entered the at least one of the one or more virtual geographic boundaries. In some embodiments, the system may be configured to detect an incidence of a computing device within a specific virtual geographic boundary by continuously scanning the virtual geographic boundary. In some other embodiments, the system may be configured to determine the location of the one or more computing devices based on at least receiving location information from the computing device and comparing the location information with the location of the merchant. In this regard, the system may be configured to initiate an application stored on the computing device to retrieve the location information from the computing device. In one aspect, the application may be installed on the computing device by the user and given permission to continuously or periodically transmit location information of the computing device.

In some embodiments, the system may be configured to establish a communication link with the one or more computing devices of the one or more users determined to have entered the at least one of the one or more virtual geographic boundaries. In response, the system may be configured to generate the one or more resource transfer requests based on at least one of the one or more virtual geographic boundaries that the one or more computing devices of the one or more users has entered, wherein generating further comprises generating the one or more resource transfer requests based on at least the one or more conditions. In one aspect, the one or more conditions may be based on the type of user. In one example, the user may be a customer of the same financial institution associated with the merchant. In another example, the one or more conditions may be based on a number of times the user has previously executed a transaction with the merchant. In yet another example, the one or more conditions may be based on a predetermined period of time that has passed since the user has executed a transaction with the merchant. Accordingly, the merchant may condition the resource transfer to be provided to users who have executed a transaction with the merchant in the three months, but not in the last month. In some embodiments, the one or more conditions may be associated with the virtual boundaries in such a way that when the user moves from a first virtual geographic boundary to second virtual geographic boundary, the system may be configured to revoke the resource transfer request associated with the first virtual geographic boundary and present the resource transfer request associated with the second virtual geographic boundary.

In response, the system may be configured to transmit, via the established communication link, control signals configured to cause the one or more computing devices of the one or more users to display the one or more resource transfer requests. In some embodiments, the system may be configured to initiate a user interface for display on the computing device of the user. In one aspect, the user interface may be integrated with one or more applications associated with the entity (e.g., financial institution) stored on the computing device. In this regard, the system may be configured to integrate the presentation of the resource transfer request with one or more features associated with the one or more applications associated with the entity. Accordingly, the system may be configured to initiate the presentation of the one or more resource transfer requests via the one or more features associated with the one or more applications associated with the entity. In some embodiments, the one or more applications may not be associated with the entity. In another aspect, the user interface may not be integrated with one or more applications associated with the entity.

In some embodiments, the system may be configured to apply the one or more conditions to the one or more resource transfer requests stored in the merchant database. In response, the system may be configured to retrieve, from the merchant database, the one or more resource transfer requests that satisfy the one or more conditions associated with the one or more virtual geographic boundaries. In response to retrieving, the system may be configured to transmit, via the established communication link, control signals configured to cause the one or more computing devices of the one or more users to display the one or more resource transfer requests that have satisfied the one or more conditions.

In some embodiments, the system may be configured to determine one or more proximate merchants that are located within the one or more virtual geographic boundaries. In response, the system may be configured to generate the one or more resource transfer requests, wherein the one or more resource transfer requests are associated with at least the subset of the one or more resources associated with the merchant and a subset of the one or more resources associated with the one or more proximate merchants that are located within the one or more virtual geographic boundaries.

In some embodiments, the system may be configured to determine one or more peer resource transfers executed by one or more peer merchants, wherein the one or more peer resource transfers are associated with one or more same or similar resources as that of the one or more resources associated with the merchant. In response, the system may be configured to initiate the analytical recommendation engine configured to generate the one or more resource transfer requests associated with at least a subset of the one or more resources associated with the merchant based on at least the one or more peer resource transfers executed by the one or more peer merchants.

In some embodiments, the system may be configured to determine that a user is within a virtual geographic boundary. In response, the system may be configured to transmit control signals configured to cause the computing device of the merchant indicating that a potential customer (the user) is within the virtual geographic boundary. In addition, the system may be configured to recommend one or more resource transfer requests for the user. In one aspect, the system may be configured to receive from the computing device of the merchant, an authorization to issue the resource transfer request to the user. In some embodiments, in addition to receiving the authorization, the system may be configured to receive one or more conditions to be applied to the resource transfer request prior to the resource transfer request being offered to the user.

In some embodiments, to recommend one or more resource transfer requests to the user, the system may be configured to determine a user preference associated with the user. A user preference may be a collection of settings and information associated with a user. It can be defined as the explicit digital representation of the identity of the user with respect to the operating environment, which may include operating systems, software applications, or websites. The user preference may help in associating characteristics with a user and in ascertaining the interactive behavior of the user along with preferences. For example, the user may be an existing customer associated with the financial institution but may have never shopped with the merchant before. The financial institution is in a unique position to identify interactive behavior of the user and the user characteristics based on at least past transactions executed by the user using a financial institution account associated with the user. Accordingly, the financial institution may be able to recommend that the merchant provide specific resource transfer requests to the user since the user is within the virtual geographic boundary.

In some embodiments, the system may be configured to enable the user to redeem the resource transfer request at the merchant location by presenting the resource transfer request to the merchant when the user is executing the resource transfer with the merchant. In such resource transfers, the resource transfer request is redeemed by the merchant at the time the user executes the resource transfer request. In some other embodiments, the system may be configured to enable the user to accept the one or more resource transfer requests via the financial institution application associated with the user and in response, store the one or more resource transfer requests in a financial institution database. In this way, when the user executes a resource transfer with the merchant, the system may be configured to determine whether any of the resource transfer requests previously accepted by the user applies to the resources associated with the resource transfers executed by the user with the merchant. In response, the system may be configured to retrieve the stored resource transfer request that applies to the resource transfer to be applied to the resource transfer. In one aspect, the resource transfer request may not be redeemable at a time the user executes the resource transfer at the merchant location. Instead, the resource transfer request is redeemed during the back-end reconciliation process when funds are transferred from the user's financial institution account to the merchant's financial institution account. For example, if the resource transfer request is a 10% discount of a resource that costs $100, when the user executes the resource transfer at the merchant location, the user executes a resource transfer for $100. At a predetermined period of time after the execution of the resource transfer when the financial institution reconciles the resource transfer the resource transfer request may be applied to the resource transfer. Thus, while the user pays $100 at the merchant location, when the funds are being transferred from the user's financial institution account to the merchant's financial institution account, the resource transfer request is redeemed and $90 is transferred instead.

In some embodiments, the system may be configured to retrieve, from the computing device of the merchant, information associated with one or more users from a contact list associated with the merchant. In response, the system may be configured to compare the information retrieve from the merchant's contact list with information associated with one or more users that are associated with the entity (e.g., financial institution) to determine a match. In response, the system may then be configured to further filter the matched results to determine which of the one or more users have either never executed a resource transfer with the merchant, or the one or more users who have executed the resource transfer with the merchant a predetermined period of time prior to the comparing. In response, the system may be configured to transmit the resource transfer request to the filtered set of users.

In some embodiments, the system may be configured to determine one or more merchant locations frequented by the user after the user has visited a financial institution location. In response, the system may be configured to transmit control signals configured to cause the computing device of the user to display one or more resource transfer requests associated with the one or more merchants.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for implementing predictive resource transfers, the system comprising:
at least one non-transitory storage device; and
at least one processing device coupled to the at least one non-transitory storage device, wherein the at least one processing device is configured to:
initiate a remote access to a computing device associated with a merchant;
request, via the remote access, information associated with one or more resources associated with the merchant;
electronically receive information associated with one or more historical resource transfers executed by one or more users within a predetermined distance from a location of the merchant, wherein the one or more historical resource transfers comprises at least one or more same or similar resources as that of the one or more resources associated with the merchant, and a time of year that the historical resource transfers were executed by the one or more users;
initiate a machine learning engine on the one or more historical resource transfers to predict a market need for the one or more resources associated with the merchant;
predict the market need for the one or more resources associated with the merchant based on at least initiating the machine learning engine on the one or more historical resource transfers; and
initiate an analytical recommendation engine configured to generate one or more resource transfer requests associated with at least a subset of the one or more resources associated with the merchant based on at least the market need.

2. The system of claim 1, wherein the at least one processing device is further configured to:
transmit control signals configured to cause the computing device associated with the merchant to display, via an authorization interface, the one or more resource transfer requests associated with at least a subset of the one or more resources associated with the merchant;
receive, via the authorization interface, a merchant input authorizing a distribution of the one or more resource transfer requests associated with at least a subset of the one or more resources associated with the merchant; and
store the one or more resource transfer requests associated with at least a subset of the one or more resources associated with the merchant in a merchant database.

3. The system of claim 2, wherein the at least one processing device is further configured to define one or more virtual geographical boundaries around a location of the merchant, wherein defining further comprises:
receiving from the computing device, the location of the merchant and one or more radial distance inputs; and
defining the one or more virtual geographic boundaries around the location of the merchant based on at least each of the one or more radial distance inputs.

4. The system of claim 3, wherein the at least one processing device is further configured to:
electronically receive, from the computing device associated with the merchant, one or more conditions associated with generating the one or more resource transfer requests for the one or more virtual geographic boundaries; and
generate the one or more resource transfer requests associated with at least the subset of the one or more resources associated with the merchant based on at least the one or more conditions.

5. The system of claim 4, wherein the at least one processing device is further configured to:
continuously scan the one or more virtual geographic boundaries for an indication that the one or more computing devices of the one or more users has entered the at least one of the one or more virtual geographic boundaries; and
electronically receive the indication that the one or more computing devices of the one or more users has entered the at least one of the one or more virtual geographic boundaries.

6. The system of claim 5, wherein the at least one processing device is further configured to:
establish a communication link with the one or more computing devices of the one or more users determined to have entered the at least one of the one or more virtual geographic boundaries;
generate the one or more resource transfer requests based on at least one of the one or more virtual geographic boundaries that the one or more computing devices of the one or more users has entered, wherein generating further comprises generating the one or more resource transfer requests based on at least the one or more conditions; and
transmit, via the established communication link, control signals configured to cause the one or more computing devices of the one or more users to display the one or more resource transfer requests.

7. The system of claim 6, wherein the at least one processing device is further configured to:
apply the one or more conditions to the one or more resource transfer requests stored in the merchant database;
retrieve, from the merchant database, the one or more resource transfer requests that satisfy the one or more conditions associated with the one or more virtual geographic boundaries; and
transmit, via the established communication link, control signals configured to cause the one or more computing devices of the one or more users to display the one or more resource transfer requests that have satisfied the one or more conditions.

8. The system of claim 7, wherein the at least one processing device is further configured to:
determine one or more proximate merchants that are located within the one or more virtual geographic boundaries; and
generate the one or more resource transfer requests, wherein the one or more resource transfer requests are associated with at least the subset of the one or more resources associated with the merchant and a subset of the one or more resources associated with the one or more proximate merchants that are located within the one or more virtual geographic boundaries.

9. The system of claim 1, wherein the at least one processing device is further configured to:
determine one or more peer resource transfers executed by one or more peer merchants, wherein the one or more peer resource transfers are associated with one or more same or similar resources as that of the one or more resources associated with the merchant; and
initiate the analytical recommendation engine configured to generate the one or more resource transfer requests associated with at least a subset of the one or more resources associated with the merchant based on at least the one or more peer resource transfers executed by the one or more peer merchants.

10. A computer implemented method for implementing predictive resource transfers, the method comprising:
initiating a remote access to a computing device associated with a merchant;
requesting, via the remote access, information associated with one or more resources associated with the merchant;
electronically receiving information associated with one or more historical resource transfers executed by one or more users within a predetermined distance from a location of the merchant, wherein the one or more historical resource transfers comprises at least one or more same or similar resources as that of the one or more resources associated with the merchant, and a time of year that the historical resource transfers were executed by the one or more users;
initiating a machine learning engine on the one or more historical resource transfers to predict a market need for the one or more resources associated with the merchant;
predicting the market need for the one or more resources associated with the merchant based on at least initiating the machine learning engine on the one or more historical resource transfers; and
initiating an analytical recommendation engine configured to generate one or more resource transfer requests associated with at least a subset of the one or more resources associated with the merchant based on at least the market need.

11. The method of claim 10, wherein the method further comprises:
transmitting control signals configured to cause the computing device associated with the merchant to display, via an authorization interface, the one or more resource transfer requests associated with at least a subset of the one or more resources associated with the merchant;
receiving, via the authorization interface, a merchant input authorizing a distribution of the one or more resource transfer requests associated with at least a subset of the one or more resources associated with the merchant; and
storing the one or more resource transfer requests associated with at least a subset of the one or more resources associated with the merchant in a merchant database.

12. The method of claim 11, wherein the method further comprises defining one or more virtual geographical boundaries around a location of the merchant, wherein defining further comprises:
receiving from the computing device, the location of the merchant and one or more radial distance inputs; and
defining the one or more virtual geographic boundaries around the location of the merchant based on at least each of the one or more radial distance inputs.

13. The method of claim 12, wherein the method further comprises:
electronically receiving, from the computing device associated with the merchant, one or more conditions associated with generating the one or more resource transfer requests for the one or more virtual geographic boundaries; and
generating the one or more resource transfer requests associated with at least the subset of the one or more resources associated with the merchant based on at least the one or more conditions.

14. The method of claim 13, wherein the method further comprises:
continuously scanning the one or more virtual geographic boundaries for an indication that the one or more computing devices of the one or more users has entered the at least one of the one or more virtual geographic boundaries; and
electronically receiving the indication that the one or more computing devices of the one or more users has entered the at least one of the one or more virtual geographic boundaries.

15. The method of claim 14, wherein the method further comprises:
establishing a communication link with the one or more computing devices of the one or more users determined to have entered the at least one of the one or more virtual geographic boundaries;
generating the one or more resource transfer requests based on at least one of the one or more virtual geographic boundaries that the one or more computing devices of the one or more users has entered, wherein generating further comprises generating the one or more resource transfer requests based on at least the one or more conditions; and
transmitting, via the established communication link, control signals configured to cause the one or more computing devices of the one or more users to display the one or more resource transfer requests.

16. The method of claim 15, wherein the method further comprises:
applying the one or more conditions to the one or more resource transfer requests stored in the merchant database;
retrieving, from the merchant database, the one or more resource transfer requests that satisfy the one or more conditions associated with the one or more virtual geographic boundaries; and
transmitting, via the established communication link, control signals configured to cause the one or more computing devices of the one or more users to display the one or more resource transfer requests that have satisfied the one or more conditions.

17. The method of claim 16, wherein the method further comprises:
determining one or more proximate merchants that are located within the one or more virtual geographic boundaries; and
generating the one or more resource transfer requests, wherein the one or more resource transfer requests are associated with at least the subset of the one or more resources associated with the merchant and a subset of the one or more resources associated with the one or more proximate merchants that are located within the one or more virtual geographic boundaries.

18. A computer program product for implementing predictive resource transfers, the computer program product comprising a non-transitory computer-readable medium comprising code causing a first apparatus to:
initiate a remote access to a computing device associated with a merchant;
request, via the remote access, information associated with one or more resources associated with the merchant;
electronically receive information associated with one or more historical resource transfers executed by one or more users within a predetermined distance from a location of the merchant, wherein the one or more historical resource transfers comprises at least one or more same or similar resources as that of the one or more resources associated with the merchant, and a time of year that the historical resource transfers were executed by the one or more users;
initiate a machine learning engine on the one or more historical resource transfers to predict a market need for the one or more resources associated with the merchant;
predict the market need for the one or more resources associated with the merchant based on at least initiating the machine learning engine on the one or more historical resource transfers; and
initiate an analytical recommendation engine configured to generate one or more resource transfer requests associated with at least a subset of the one or more resources associated with the merchant based on at least the market need.

19. The computer program of claim 18, wherein the first apparatus is further configured to:
transmit control signals configured to cause the computing device associated with the merchant to display, via an authorization interface, the one or more resource transfer requests associated with at least a subset of the one or more resources associated with the merchant;
receive, via the authorization interface, a merchant input authorizing a distribution of the one or more resource transfer requests associated with at least a subset of the one or more resources associated with the merchant; and
store the one or more resource transfer requests associated with at least a subset of the one or more resources associated with the merchant in a merchant database.

20. The computer program of claim 19, wherein the first apparatus is further configured to define one or more virtual geographical boundaries around a location of the merchant, wherein defining further comprises:
receiving from the computing device, the location of the merchant and one or more radial distance inputs; and
defining the one or more virtual geographic boundaries around the location of the merchant based on at least each of the one or more radial distance inputs.
